(19) United States
(12) Patent Application Publication
(10) Pub. No.: US 2011/0316685 A1
(43) Pub. Date: Dec. 29, 2011

(54) METHOD AND APPARATUS FOR CONTROLLING LANE KEEPING AND APPARATUS FOR WARNING OF ESCAPE FROM LANE

(75) Inventor: Soon Tae KIM, Yongin-si (KR)

(73) Assignee: MANDO CORPORATION

(21) Appl. No.: 13/107,457

(22) Filed: May 13, 2011

(30) Foreign Application Priority Data
Jun. 24, 2010 (KR) 10-2010-0059995

(51) Int. Cl. B60Q 1/00

(52) U.S. Cl. 340/435

(57) ABSTRACT

The disclosure relates to a lane keeping control method and apparatus, and an apparatus for warning of a lane escape. More particularly, the disclosure relates to a method and an apparatus for controlling lane keeping and an apparatus for warning of an escape from a lane, which generate a lane escape warning only on a specific condition in which a vehicle is expected to actually escape from a lane, so that the apparatus and method can reduce the generation of an unnecessary lane escape warning that may cause the inconvenience of a driver.

### CROSS-REFERENCE TO RELATED APPLICATION

This application claims priority from and the benefit under 35 U.S.C. §19(a) of Korean Patent Application No. 10-2010-0059995, filed on Jun. 24, 2010, which is hereby incorporated by reference for all purposes as if fully set forth herein.

### BACKGROUND OF THE INVENTION

1. Field of the Invention

The present invention relates to a lane keeping control method and apparatus, and an apparatus for warning of a lane escape. More particularly, the present invention relates to a method and an apparatus for controlling lane keeping and an apparatus for warning of an escape from a lane, which generate a lane escape warning only on a specific condition in which a vehicle is expected to actually escape from a lane, so that the apparatus and method can reduce the generation of an unnecessary lane escape warning that may cause the inconvenience of a driver.

2. Description of the Prior Art

In general, a conventional apparatus for lane keeping control (hereinafter, also referred to as ‘a lane escape prevention controlling apparatus’) of a vehicle starts the lane keeping control and generates the lane escape warning when the vehicle arrives at a starting point for the aforementioned lane keeping control. Otherwise, as soon as the vehicle arrives at a lane escape warning generation point before the vehicle escapes from the lane during the lane keeping control, the lane keeping control apparatus generates the lane escape warning.

If the lane keeping control is performed and as a result, the lane escape is prevented and the lane keeping is accomplished, the lane escape warning generated according to the vehicle arriving at the lane keeping control starting point or the lane escape warning generation point before the generation of the actual lane escape may not be necessary. That is, the conventional lane keeping control apparatus may generate the unnecessary lane escape warnings too frequently, which may therefore cause the inconvenience of the driver.

### SUMMARY OF THE INVENTION

Accordingly, the present invention has been made to solve the above-mentioned problems occurring in the prior art, and an object of the present invention is to provide a method and an apparatus for controlling lane keeping, which limits the generation of a lane escape warning when it is possible to prevent the land escaping under a lane keeping control, so that it is possible to control lane keeping while reducing the generation of an unnecessary lane escape warning that may cause the inconvenience of a driver.

Another object of the present invention is to provide an apparatus for controlling a lane escape warning, which generates a lane escape warning only on a specific condition in which a lane escape is expected to be actually generated, so that it reduces the generation of an unnecessary lane escape warning that may cause the inconvenience of a driver.

In order to accomplish this object, there is provided an apparatus for controlling lane keeping, including: a lane keeping controller for determining an expected lane escape situation based on a sensed vehicle's position and a sensed lane and performing a lane keeping control; a lane escape prevention possibility determination unit for determining if it is possible to prevent a lane escaping under the lane keeping control based on a state of the lane keeping control and a state of a vehicle after the performing of the lane keeping control; and a lane escape warning controller for limiting a lane escape warning when it is determined that it is possible to prevent the lane escaping, and generating a lane escape warning when it is determined that it is impossible to prevent the lane escaping.

In accordance with another aspect of the present invention, there is provided a method for controlling lane keeping, the method including the steps of: determining an expected lane escape situation based on a sensed vehicle's position and a sensed lane; determining if it is possible to prevent a lane escaping under a lane keeping control based on a state of the lane keeping control and a state of a vehicle, after the performing of the lane keeping control; and limiting a lane escape warning when it is determined that it is possible to prevent the lane escaping, and generating a lane escape warning when it is determined that it is impossible to prevent the lane escaping.

In accordance with another aspect of the present invention, there is provided an apparatus for warning of a lane escaping, the apparatus including: a heading angle variation rate monitoring unit for monitoring a heading angle variation rate of a heading angle between a lane indication line and a vehicle; a lane escape prevention possibility determination unit for calculating a vehicle position returnable time at which a progress direction of the vehicle is expected to return to an inner side of the lane of a road based on a result of the monitored heading angle variation rate, calculating an expected lane escape time at which the vehicle is expected to reach the lane indication line, comparing the vehicle position returnable time and the expected lane escape time, and determining if it is possible to prevent the lane escaping based on a result of the comparison; and a lane escape warning controller for limiting a lane escape warning when it is determined that it is possible to prevent the lane escaping, and generating a lane escape warning when it is determined that it is impossible to prevent the lane escaping.

As described above, the method and the system for the lane keeping control according to the present invention limit the generation of the lane escape warning when it is possible to prevent the land escaping under the lane keeping control, so the method and the system can effectively perform the lane keeping control while reducing the generation of the unnecessary lane escape warning that may cause the inconvenience of the driver.

Further, the apparatus for controlling the lane escape warning according to the present invention generates the lane escape warning only on a specific condition in which the lane escape is expected to actually occur, so that it reduces the generation of the unnecessary lane escape warning that may cause the inconvenience of the driver.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a lane keeping control apparatus according to an embodiment of the present invention;

FIG. 2 is a view illustrating a lane keeping control starting point for a lane keeping control and a lane escape warning generation point for a lane escape warning in a lane keeping control apparatus according to an embodiment of the present invention;

FIG. 3 is a view exemplarily illustrating a situation for description of a method for determining if it is possible to prevent a lane escaping under a lane keeping control in a lane keeping control apparatus according to an embodiment of the present invention;

FIG. 4 is a view exemplarily illustrating a situation in which a lane escape warning is limited when it is determined that it is possible to prevent a lane escaping according to a lane keeping control in a lane keeping control apparatus according to an embodiment of the present invention;

FIG. 5 is a view exemplarily illustrating a situation in which a lane escape warning is generated when it is determined that it is impossible to prevent a lane escaping under a lane keeping control in a lane keeping control apparatus according to an embodiment of the present invention;

FIG. 6 is a flowchart illustrating a method for controlling lane keeping according to an embodiment of the present invention; and

FIG. 7 is a block diagram illustrating a lane escape warning control apparatus according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

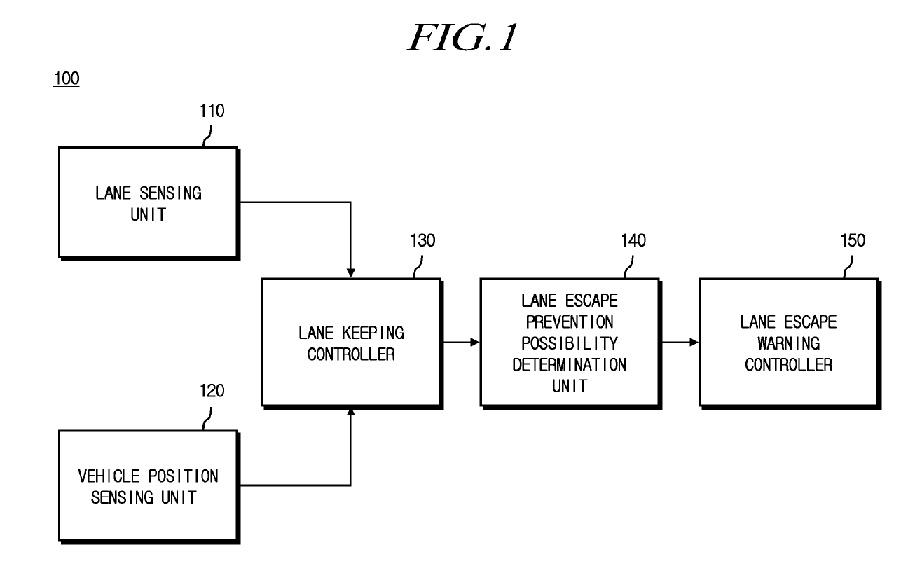

FIG. 1 is a block diagram illustrating a lane keeping control apparatus 100 according to an embodiment of the present invention.

Referring to FIG. 1, the lane keeping control apparatus 100 according to the embodiment of the present invention includes a lane keeping controller 130, a lane escape prevention possibility determination unit 140, and a lane escape warning controller 150. The lane keeping controller 130 determines an expected lane escape situation based on a sensed vehicle position and a sensed lane and performs a lane keeping control. The lane escape prevention possibility determination unit 140 determines if it is possible to prevent a lane escaping under the lane keeping control based on a state of the lane keeping control and a state of the vehicle after the lane keeping control by the lane keeping controller 130. The lane escape warning controller 150 limits a lane escape warning when it is determined that it is possible to prevent the lane escaping and generates the lane escape warning when it is determined that it is impossible to prevent the lane escaping.

As illustrated in FIG. 1, the lane keeping control apparatus 100 according to the embodiment of the present invention can further include a lane sensing unit 110 for sensing a lane through a lane sensor or a camera and a vehicle position sensing unit 120 for sensing a position of a vehicle through a vehicle position sensor.

When a sensed vehicle position reaches a lane keeping control starting point obtained based on a sensed lane, the lane keeping controller 130 determines that it is an expected lane escape situation and performs the lane keeping control. Here, the lane keeping control is performed through generating a steering torque for the lane escape prevention.

The aforementioned lane keeping control starting point may be a point spaced apart from a lane indication line toward the lane center by a predetermined distance or a point spaced apart from the lane center toward a lane indication line by a predetermined distance. Further, in a road having a uniform lane width, the lane keeping control starting point may be a point spaced apart from a lane indication line toward the lane center or from the lane center toward a lane indication line by a distance variable according to the vehicle's state, including the speed or the driving direction of the vehicle.

In general, a conventional apparatus for lane keeping control (hereinafter, also referred to as ‘a lane escape prevention controlling apparatus’) of a vehicle starts the lane keeping control and generates the lane escape warning when the vehicle arrives at a starting point for the aforementioned lane keeping control. Otherwise, as soon as the vehicle arrives at a lane escape warning generation point before the vehicle escapes from the lane during the lane keeping control, the lane keeping control apparatus generates the lane escape warning.

If the lane keeping control is performed and as a result, the lane escape is prevented and the lane keeping is accomplished, the lane escape warning generated according to the vehicle arriving at the lane keeping control starting point or the lane escape warning generation point before the generation of the actual lane escape may not be necessary. That is, the conventional lane keeping control apparatus may generate the unnecessary lane escape warnings too frequently, which may therefore cause the inconvenience of the driver.

Contrary to this, even though the vehicle reaches the lane escape warning generation point before escaping from the lane during the performance of the lane keeping control, when it is determined that it is possible to prevent the lane escaping according to the currently performing lane keeping control, the lane keeping control apparatus 100 according to the embodiment of the present invention limits the generation of the lane escape warning, and when it is determined that it is impossible to prevent the lane escaping under the currently performing lane keeping control, the lane keeping control apparatus 100 generates the lane escape warning. Therefore, the lane keeping control apparatus 100 does not generate an unnecessary lane escape warning, but generates the lane escape warning only in an essentially necessary case.

Here, the lane escape warning generation point may be a point spaced apart from a lane indication line toward the lane center by a predetermined distance or a point spaced apart from the lane center toward a lane indication line by a predetermined distance. Further, in a road having a uniform lane width, the lane escape warning generation point may be a point spaced apart from a lane indication line toward the lane center by a variable distance or from the lane center toward a lane indication line by a variable distance according to the vehicle's state, including the speed or driving direction of the vehicle.

As described above, in order to generate a lane escape warning in an essentially necessary case without the generation of the unnecessary lane escape warning, it is necessary to determine if it is possible to prevent the lane escaping under the currently performing lane keeping control, and such a determination is performed in the lane escape prevention possibility determination unit 140.

The lane escape prevention possibility determination unit 140 will be described in more detail below.

After the lane keeping control by the lane keeping controller 130, the lane escape prevention possibility determination unit 140 determines if it is possible to prevent the land escaping under the lane keeping control by the lane keeping controller 130 based on a heading angle variation rate (which can be received from the camera mounted on the vehicle) of a heading angle between the lane indication line and the vehicle, in which the heading angle variation rate is calculated based on a state of the lane keeping control and a state of the vehicle.

More particularly, the lane escape prevention possibility determination unit 140 can calculate a vehicle position returnable time, at which a vehicle progress direction is expected to return to the inner side of the lane, based on the heading angle variation rate calculated on a basis of the state of the lane keeping control and the state of the vehicle, calculate an expected lane escape time at which the vehicle is expected to reach the lane indication line, compare the vehicle position returnable time with the expected lane escape time, and determine if it is possible to prevent the lane escaping under the lane keeping control based on a result of the comparison.

Further, the lane escape prevention possibility determination unit 140 can calculate the expected lane escape time, at which the vehicle is expected to escape from the lane, based on the heading angle variation rate obtained on a basis of the state of the lane keeping control and the state of the vehicle, calculate a target torque value for the lane escape prevention based on the state of the lane keeping control and the state of the vehicle, and determine if the lane keeping control apparatus 100 can change a torque value to the calculated target torque value within the calculated expected lane escape time, to determine if it is possible to prevent the lane escaping under the control of the lane keeping. That is, when it is determined that the lane keeping control apparatus 100 can change the torque value to the calculated target torque value within the calculated expected lane escape time, the lane escape prevention possibility determination unit 140 determines that it is possible to prevent the lane escaping, and when it is determined that the lane keeping control apparatus 100 can change the torque value to the calculated target torque value within the calculated expected lane escape time, the lane escape prevention possibility determination unit 140 determines that it is impossible to prevent the lane escaping.

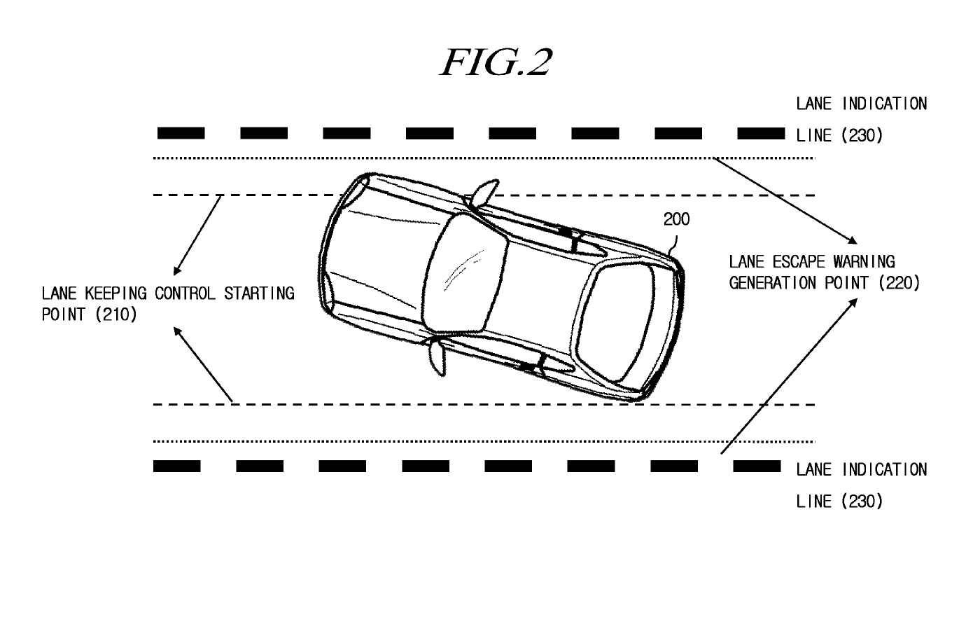

The lane keeping control and the control of the generation of the lane escape warning performed by the lane keeping control apparatus 100 according to the embodiment of the present invention will be exemplarily described with reference to FIGS. 2 to 5.

FIG. 2 is a view illustrating the lane keeping control starting point for the lane keeping control and the lane escape warning generation point for the lane escape warning in the lane keeping control apparatus 100 according to the embodiment of the present invention.

The lane escape warning generation point may generally be a point closer to the lane indication line than the lane keeping control starting point. Therefore, the lane keeping control can be preferentially performed in comparison with the lane escape warning in general.

Referring to FIG. 2, when it is sensed that a position of a vehicle 200 driving within a lane indication line 230 reaches a lane keeping control starting point 210, the lane keeping control apparatus 100 considers this situation as an expected lane escape situation and starts the lane keeping control, and generates a steering torque in a direction of the road center in connection with a steering control apparatus, thereby performing the lane keeping control.

Even under the lane keeping control, the vehicle 200 may reach a lane escape warning generation point 220. In this case, the lane keeping control apparatus 100 according to the embodiment of the present invention does not unconditionally generate the lane escape warning, but preferentially determines if it is possible to prevent the lane escaping under the lane keeping control. After the determination of the possibility of the lane escape prevention, only when the lane keeping control apparatus 100 determines that the lane escape of the vehicle 200 cannot be prevented under the lane keeping control under the lane keeping control, it generates the lane escape warning.

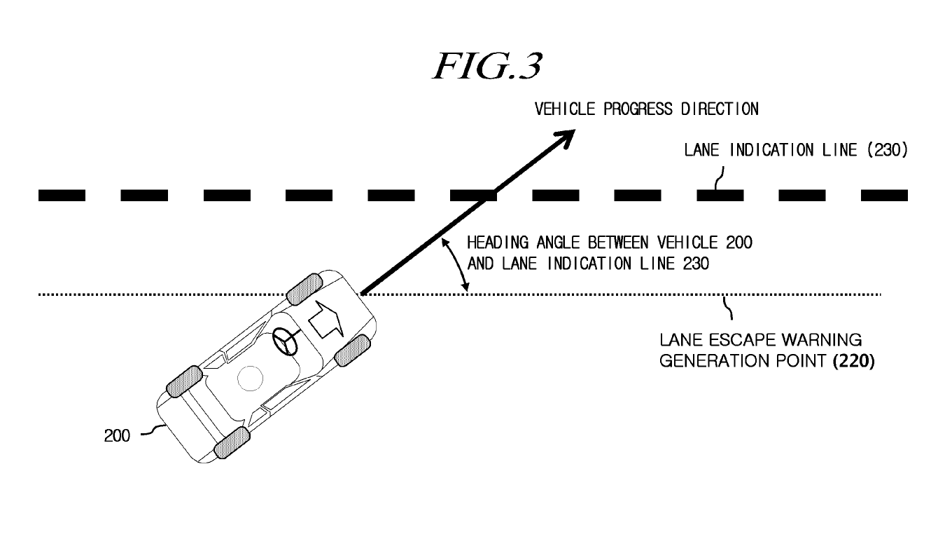

In order to generate the lane escape warning only when the lane escape cannot be prevented, the lane keeping control apparatus 100 must accurately determine if it is possible to prevent the lane escaping of the vehicle 200. A method for determining if it is possible to prevent the lane escaping will be described with reference to FIG. 3.

Referring to FIG. 3, the lane keeping control apparatus 100 recognizes how much a heading angle between the vehicle 200 and the lane indication line 230 is varied under the lane keeping control and obtains a heading angle variation rate based on a state of a vehicle 200, which reaches the lane keeping control starting point 210 and is under the lane keeping control, and a state (control quantity) of the currently performing lane keeping control, calculates a vehicle position returning possibility time, at which a vehicle progress direction is expected to return to the inner side of the lane, according to the calculated heading angle variation rate, calculates an expected lane escape time at which the vehicle 200 is expected to reach the lane indication line 230, compares the vehicle position returning possibility time with the expected lane escape time, and determines if it is possible to prevent the lane escaping under the lane keeping control based on a result of the comparison.

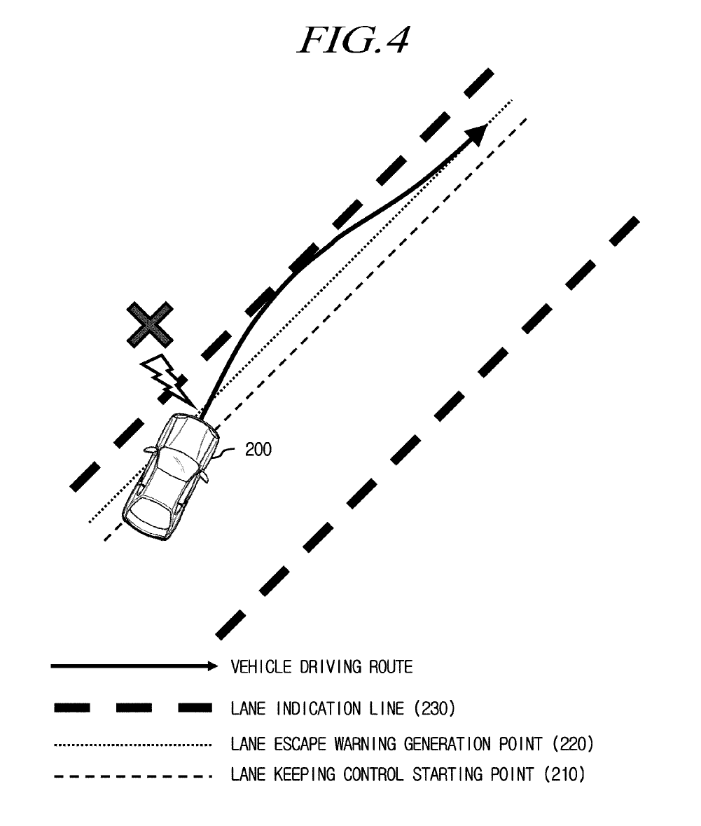

If the vehicle position returning possibility time is shorter than the expected lane escape time, i.e. it is possible to prevent the lane escaping under the currently performing lane keeping control, the lane keeping control apparatus 100 limits the generation of the lane escape warning, a case of which is exemplarily illustrated in FIG. 4. Referring to FIG. 4, in regard to the determination that it is possible to prevent the lane escaping under the currently performing lane keeping control, it can be identified that a driving route of the vehicle 200 does not escape from the lane indication line 230.

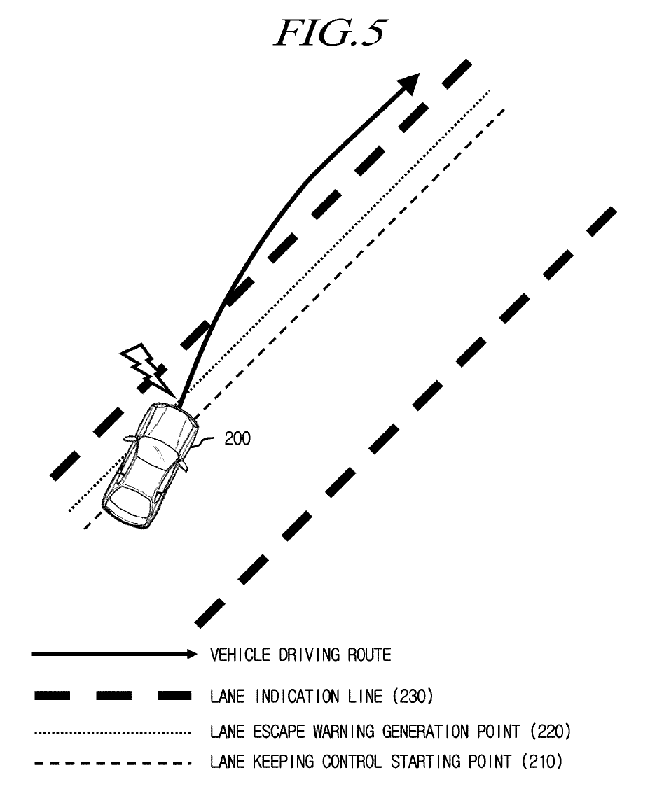

If the vehicle position returning possibility time is longer than the expected lane escape time, i.e. it is impossible to prevent the lane escaping under the currently performing lane keeping control, the lane keeping control apparatus 100 generates the lane escape warning, a case of which is exemplarily illustrated in FIG. 5. Referring to FIG. 5, in regard to the determination that it is impossible to prevent the lane escaping under the currently performing lane keeping control, it can be identified that a driving route of the vehicle 200 escapes from the lane indication line 230.

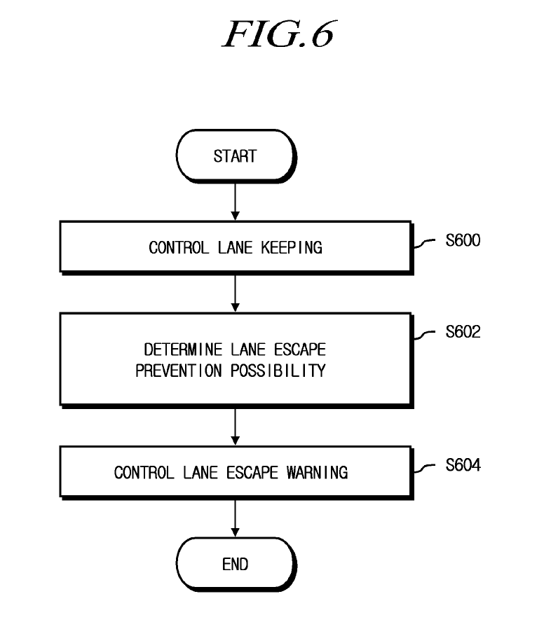

FIG. 6 is a flowchart illustrating a method for lane keeping control by the lane keeping control apparatus 100 according to the embodiment of the present invention.

Referring to FIG. 6, the method for the lane keeping control according to the embodiment of the present invention includes a lane keeping control step (S600) for determining an expected lane escape situation based on a sensed vehicle's position and a sensed lane and performing the lane keeping control, a lane escape prevention possibility determination step (S602) for, after performing the lane keeping control, determining if it is possible to prevent the lane escaping according to the currently performing lane keeping control based on a state of the lane keeping control and a state of a vehicle, and a lane escape warning control step (S604) for limiting the generation of the lane escape warning when it is determined that it is possible to prevent the lane escaping and generating the lane escape warning when it is determined that it is impossible to prevent the lane escaping.

As described above, the lane keeping control apparatus 100 and the method for the lane keeping control limit the generation of the lane escape warning when it is possible to prevent the lane escaping under the lane keeping control, so that they effectively perform the lane keeping control while reducing the generation of the unnecessary lane escape warning that may cause the inconvenience of the driver.

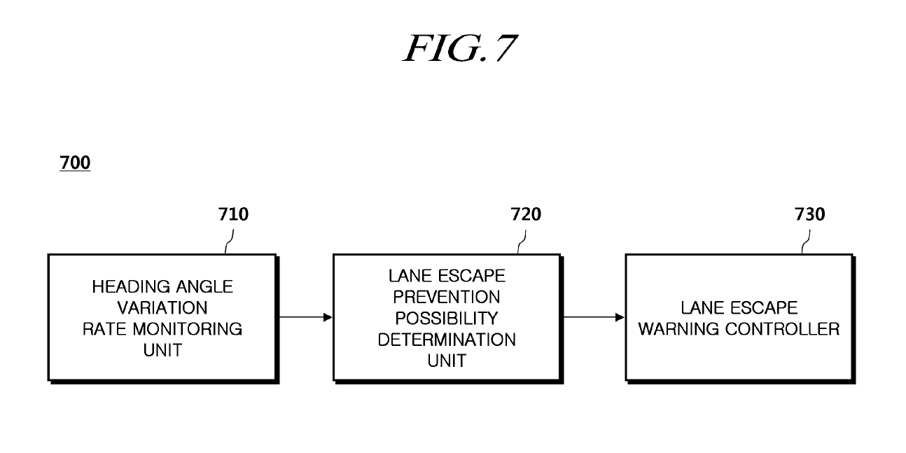

FIG. 7 is a block diagram illustrating a lane escape warning control apparatus 700 according to an embodiment of the present invention.

Referring to FIG. 7, the lane escape warning control apparatus 700 according to the embodiment of the present invention includes a heading angle variation rate monitoring unit 710, a lane escape prevention possibility determination unit 720, and a lane escape warning controller 730. The heading angle variation rate monitoring unit 710 monitors a heading angle variation rate for a heading angle between a lane indication line and a vehicle. The lane escape prevention possibility determination unit 720 calculates a vehicle position returnable time, at which a vehicle progress direction is expected to return to the inner side of the lane, based on a monitoring result of the heading angle variation rate of the heading angle between the lane indication line and the vehicle, calculates an expected lane escape time at which the vehicle is expected to reach the lane, compares the vehicle position returnable time with the expected lane escape time, and determines if it is possible to prevent the lane escaping based on a result of the comparison. The lane escape warning controller 730 limits the generation of the lane escape warning when it is determined that it is possible to prevent the lane escaping and generates the lane escape warning when it is determined that it is impossible to prevent the lane escaping.

The lane escape warning control apparatus 700 shown in FIG. 7 according to the embodiment of the present invention can determine if it is possible to prevent the lane escaping under the currently performing lane keeping control and control the generation of the lane escape warning based on a result of the determination, similar with the lane keeping control apparatus 100 illustrated in FIG. 1 according to the embodiment of the present invention.

Further, the lane escape warning control apparatus 700 shown in FIG. 7 according to the embodiment of the present invention does not unconditionally generate a lane escape warning even in a situation where a steering is performed only by the driver without the lane keeping control, but calculates the vehicle position returnable time and the expected lane escape time based on the state of the currently driving vehicle, determines if it is possible to prevent the lane escaping based on a result of the calculation, and thus controls the generation of the lane escape warning based on a result of the determination, different from the lane keeping control apparatus 100 illustrated in FIG. 1 according to the embodiment of the present invention.

As described above, the lane escape warning control apparatus 700 according to the embodiment of the present invention generates the lane escape warning only on a specific condition in which the vehicle is expected to actually escape from the lane (a condition if the currently driving vehicle can be prevented from escaping from the lane, for example, the vehicle position returnable time>expected lane escape time), so that it effectively reduces the generation of the unnecessary lane escape warning that may cause the inconvenience of the driver.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without escaping from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An apparatus for controlling lane keeping, comprising:
a lane keeping controller for determining an expected lane escape situation based on a sensed vehicle's position and a sensed lane and performing a lane keeping control;
a lane escape prevention possibility determination unit for determining if it is possible to prevent a lane escaping under the lane keeping control based on a state of the lane keeping control and a state of a vehicle after the performing of the lane keeping control; and
a lane escape warning controller for limiting a lane escape warning when it is determined that it is possible to prevent the lane escaping, and generating a lane escape warning when it is determined that it is impossible to prevent the lane escaping.

2. The apparatus as claimed in claim 1, further comprising:
a lane sensing unit for sensing the lane through a lane sensor or a camera; and
a vehicle position sensing unit for sensing the vehicle's position through a vehicle's position sensor.

3. The apparatus as claimed in claim 1, wherein when the sensed vehicle's position reaches a lane keeping control starting point obtained based on the sensed lane, the lane keeping controller determines that the vehicle is in the expected lane escape situation, and controls the lane keeping.

4. The apparatus as claimed in claim 1, wherein the lane escape prevention possibility determination unit determines if it is possible to prevent the lane escaping under the lane keeping control, based on a heading angle variation rate of a heading angle between a lane indication line and the vehicle, after the performing of the lane keeping control, the heading angle variation rate being calculated based on the state of the lane keeping control and the state of the vehicle.

5. The apparatus as claimed in claim 4, wherein the lane escape prevention possibility determination unit calculates a vehicle position returnable time, at which a progress direction of the vehicle is expected to return to an inner side of the lane of a road, based on the heading angle variation rate, calculates an expected lane escape time, at which the vehicle is expected to reach the lane indication line, and compares the vehicle position returnable time and the expected lane escape time, and determines if it is possible to prevent the lane escaping under the lane keeping control based on a result of the comparison.

6. The apparatus as claimed in claim 4, wherein the lane escape prevention possibility determination unit calculates an expected lane escape time, at which the vehicle is expected to escape from the lane, based on the heading angle variation rate, calculates a target torque value for the lane escape prevention based on the state of the lane keeping control and the state of the vehicle, determines if a torque value can be changed to the calculated target torque value by the lane keeping control apparatus within the calculated expected lane escape time, and determines if it is possible to prevent the lane escaping under the lane keeping control.

7. The apparatus as claimed in claim 1, wherein even though the sensed vehicle's position reaches a lane escape warning generation point obtained based on the sensed lane, when it is determined that it is possible to prevent the lane escaping, the lane escape warning controller limits the generation of the lane escape warning.

8. A method for controlling lane keeping, the method comprising the steps of:
determining an expected lane escape situation based on a sensed vehicle's position and a sensed lane;
determining if it is possible to prevent a lane escaping under a lane keeping control based on a state of the lane keeping control and a state of a vehicle, after the performing of the lane keeping control; and
limiting a lane escape warning when it is determined that it is possible to prevent the lane escaping, and generating a lane escape warning when it is determined that it is impossible to prevent the lane escaping.

9. An apparatus for warning of a lane escaping, the apparatus comprising:
a heading angle variation rate monitoring unit for monitoring a heading angle variation rate of a heading angle between a lane indication line and a vehicle;
a lane escape prevention possibility determination unit for calculating a vehicle position returnable time at which a progress direction of the vehicle is expected to return to an inner side of the lane of a road based on a result of the monitored heading angle variation rate, calculating an expected lane escape time at which the vehicle is expected to reach the lane indication line, comparing the vehicle position returnable time and the expected lane escape time, and determining if it is possible to prevent the lane escaping based on a result of the comparison; and
a lane escape warning controller for limiting a lane escape warning when it is determined that it is possible to prevent the lane escaping, and generating a lane escape warning when it is determined that it is impossible to prevent the lane escaping.
